(19) United States
(12) Patent Application Publication
(10) Pub. No.: US 2008/0311856 A1
(43) Pub. Date: Dec. 18, 2008

(54) Method and Apparatus for Power Control of an Air Interface Transmission

(75) Inventor: Jonathan P. Wallington, Avon (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/995,116

(22) PCT Filed: Jun. 2, 2006
(86) PCT No.: PCT/US2006/021565

§ 371 Date: Jan. 9, 2008

(30) Foreign Application Priority Data
Jul. 20, 2005 (GB) 0514900.0

(51) Int. Cl. H01Q 11/12

(52) U.S. Cl. 455/67.13; 455/127.1

(57) ABSTRACT

An apparatus (101) performs power control for an air interface transmission between a receiver (105) and a transmitter (103). The apparatus (101) comprises a power control processor (113) which operates a power control loop for the air interface transmission in response to an error parameter. A discarded data processor (117) determines a discarded data measure indicating an amount of data actively discarded for the air interface transmission; and an error parameter processor (115) determines the error parameter in response to the discarded data measure. The data may be discarded in response to an evaluation of a delay criterion. The invention may allow power control to dynamically adjust both error rate and delay characteristics for the transmission.

### FIELD OF THE INVENTION

The invention relates to a method and apparatus for power control of an air interface transmission and in particular, but not exclusively, to power control in a cellular communication system.

### BACKGROUND OF THE INVENTION

In a cellular communication system a geographical region is divided into a number of cells each of which is served by a base station. The base stations are interconnected by a fixed network which can communicate data between the base stations. A mobile station is served via a radio communication link by the base station of the cell within which the mobile station is situated.

As a mobile station moves, it may move from the coverage of one base station to the coverage of another, i.e. from one cell to another. As the mobile station moves towards a base station, it enters a region of overlapping coverage of two base stations and within this overlap region it changes to be supported by the new base station. As the mobile station moves further into the new cell, it continues to be supported by the new base station. This is known as a handover or handoff of a mobile station between cells.

A typical cellular communication system extends coverage over typically an entire country and comprises hundreds or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems are currently being rolled out to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

Common to all types of cellular communication systems is that it is imperative to manage the radio links between the base stations and the mobile stations such that the resource used by a given communication link is as low as possible. Thus, it is important to minimise the interference caused by the communication to or from a mobile station, and consequently it is important to use the lowest possible transmit power. As the required transmit power depends on the instantaneous propagation conditions, it is necessary to dynamically control transmit powers to closely match the conditions. For this purpose, the base stations and mobile stations operate power control loops, where the receiving end reports information on the receive quality back to the transmitting end, which in response adjusts it's transmit power.

In UMTS, both an inner power control loop and an outer power control loop are implemented. Inner loop power control operates as follows. The receiving entity of a radio link measures the received signal to noise (interference) ratio (SIR), and compares it to a locally stored target SIR. A command is sent back to the transmitter to increase transmitted power if the measured SIR is less than the target. Conversely, if the measured SIR is greater than the target, a command is sent to the transmitter to decrease the transmitted power. The target SIR is set by a known feature called outer loop power control. Its function is to maintain the frame error rate (FER) or BLock Error Rate (BLER) of the radio link around a given value or threshold. The FER or BLER of the received signal is measured by one of a number of known techniques, and the SIR target is adjusted to try to ensure that the FER or BLER is at or below the given value.

In recent years, the flexibility and variety of communication services supported by a cellular communication system has increased significantly. For example, 3rd generation systems, such as UMTS, along with enhancements to 2nd generation systems, such as GPRS, have introduced a number of services known as Acknowledge Mode (AM) services. For AM services, the receiving end provides feedback to the transmitting end indicating whether data has been successfully received or not. Specifically, data may be sent in distinct blocks and for each block a positive acknowledge message (ACK) indicating that the block was received successfully or a negative acknowledge message (NACK) indicating that the block was not received successfully may be sent. If a NACK is received, the transmitting end retransmits one or more of the data blocks. Thus, the AM services use retransmissions to compensate for transmission errors.

Although retransmission schemes and power control are efficient for controlling the transmission characteristics in many scenarios, there are some disadvantages associated with the known techniques.

In particular, for some communication services, the conventional control mechanisms fail to provide optimum performance. For example, for delay sensitive data, such as e.g. video or audio streaming, high air interface error rates may result in increased retransmissions which may introduce delays. Furthermore, if this delay increases beyond a certain amount, the data to be retransmitted may become useless to a receiver resulting in a quality degradation for the service.

Furthermore, the impact of transmission errors on the delay of a service depends on the characteristics of the errors and may vary dynamically. For example, for a given error rate, an even distribution of errors can typically be corrected by a forward error correcting coding resulting in very few or no retransmissions being required. However, if the same error rate results from errors concentrated in short bursts (e.g. due to a periodic interferer), the forward error correcting coding for a given data packet will typically not be adequate for the data packets experiencing the high error rate. Thus, the same error rate may result in a high number of retransmissions with resulting delays.

Hence, an improved system for power control would be advantageous and in particular a system allowing increased flexibility, improved performance, reduced interference, reduced delay, improved adaptability and/or an improved resource utilisation would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for power control of an air interface transmission between a receiver and a transmitter; the apparatus comprising: means for operating a power control loop for the air interface transmission in response to an error parameter; first determining means for determining a discarded data measure indicating an amount of data actively discarded for the air interface transmission; and second determining means for determining the error parameter in response to the discarded data measure.

The invention may allow improved power control. In particular, the inventor of the present invention has realised that improved power control may be achieved by performing power control not only in response to transmission errors but also in response to actively discarded data. As the actively discarded data may be discarded due to the performance of the air interface transmission, the invention may allow improved performance wherein power control may better adapt to the current conditions. For example, reduced delays may result from an improved power control performance. Also an automatic and improved adaptation to current conditions may be achieved. The improved power control performance may result in reduced interference, reduced delay and/or improved resource utilisation for the communication system comprising the transmitter and receiver as a whole. The power control may improve performance by controlling more than one characteristic of a transmission and/or may allow an improved trade-off between different error control mechanisms.

The data may be actively discarded by an intentional deletion or discard of data which meets (or fails to meet) a specific criterion. Thus, the discarded data may correspond to data which is discarded rather than transmitted (or retransmitted) from the transmitter. The discarded data measure may for example indicate how large an amount of data has been discarded or may e.g. just indicate that a data discard has occurred. The error parameter may be a binary parameter.

According to an optional feature of the invention, the error parameter is an error rate difference between a measured error rate and a target error rate.

This allows a practical and efficient implementation compatible with existing systems.

According to an optional feature of the invention, the second determining means is arranged to increase the measured error rate in response to an increasing amount of discarded data.

This provides for improved power control and a practical implementation.

According to an optional feature of the invention, the second determining means is arranged to determine the measured error rate by combining transmission errors and the amount of data actively discarded.

This provides for improved power control and a practical implementation. The feature may specifically allow the measured error rate to reflect both errors occurring in the transmission over the air interface as well as errors resulting from data actively being discarded.

According to an optional feature of the invention, the second determining means is arranged to decrease the target error rate in response to increasing amount of discarded data.

This provides for improved power control and a practical implementation.

According to an optional feature of the invention, the second determining means comprises means in the receiver for modifying a reference parameter for the error parameter in response to the discarded data measure.

This provides for improved power control and a practical implementation.

According to an optional feature of the invention, the second determining means is arranged to determine the error parameter in response to a measured parameter and to modify the measured parameter in response to the discarded data measure.

This provides for improved power control and a practical implementation.

According to an optional feature of the invention, the transmitter comprises means for actively discarding data and means for transmitting an indication of the data discard to the receiver.

This provides for improved power control and a practical implementation. In particular, it may allow a practical distribution of functionality.

According to an optional feature of the invention, the first determining means is located in the receiver.

This provides for improved power control and a practical implementation. In particular, it may allow a practical distribution of functionality.

According to an optional feature of the invention, the transmitter comprises means for retransmitting data over the air interface and the actively discarded data is actively discarded retransmission data.

The invention may allow improved power control and may in particular allow improved combined performance of power control and retransmission schemes to provide an air interface transmission with improved quality of service. An improved trade-off and/or interoperability of the different error control mechanisms may be achieved.

According to an optional feature of the invention, the actively discarded data is first data discarded in response to a determination of a delay requirement for the first data being exceeded.

This may allow improved power control and may in particular provide improved delay performance by automatic adaptation of the power control to the current characteristics.

According to an optional feature of the invention, the power control loop comprises an inner power control loop and an outer power control loop and wherein the error parameter is an error parameter for the outer power control look and the outer power control loop is arranged to determine an inner target parameter. The inner target parameter may be a signal to noise parameter.

This may allow improved power control and may in particular provide high performance and/or a practical and efficient implementation compatible with existing systems. The signal to noise parameter may be a parameter reflecting an interference level.

According to an optional feature of the invention, the air interface transmission is an air interface transmission of a delay sensitive service.

The invention may improve performance of a delay sensitive service and may in particular reduce delay and/or data lost due to unacceptable transmission delays.

A communication system may comprise an apparatus as described above.

The communication system may be a cellular communication system and specifically may be a Universal Mobile Telecommunication System (UMTS).

The invention may allow improved performance in a cellular communication system and in particular in a UMTS system.

The invention may e.g. be applied to an uplink and/or downlink air interface transmission.

According to a second aspect of the invention, there is provided, a method of power control of an air interface transmission between a receiver and a transmitter; the method comprising: operating a power control loop for the air interface transmission in response to an error parameter; determining a discarded data measure indicating an amount of data actively discarded for the air interface transmission; and determining the error parameter in response to the discarded data measure.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a communication system 100 comprising an apparatus for power control in accordance with some embodiments of the invention;

FIG. 2 illustrates a simplified block diagram of a base station and a user equipment of a cellular communication system in accordance with some embodiments of the invention; and

FIG. 3 illustrates a method power control of an air interface transmission between a receiver and a transmitter in accordance with some embodiments of the invention.

### DETAILED DESCRIPTION OF SOME EMBODIMENTS OF THE INVENTION

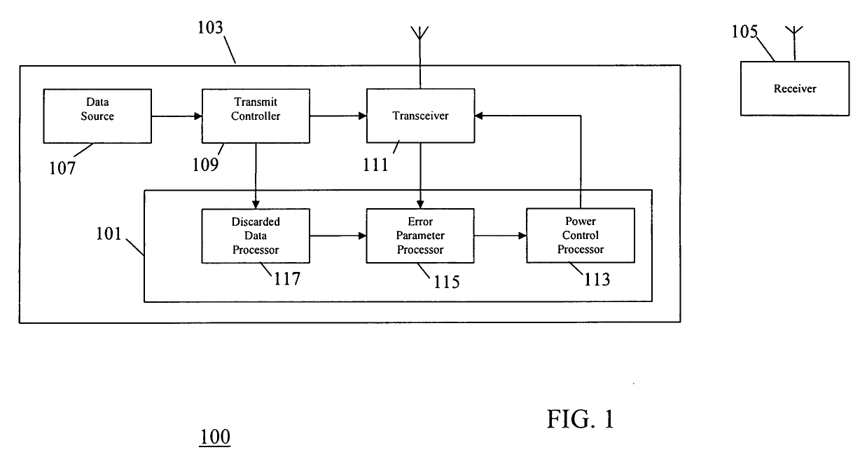

FIG. 1 illustrates a communication system 100 comprising an apparatus 101 for power control in accordance with some embodiments of the invention.

In the example, a transmitter 103 is communicating over a radio air interface communication link to a receiver 105. The example will be described with reference to power control of transmissions from the transmitter 103 to the receiver 105. However, the terms transmitter and receiver are not intended to limit the functionality of the corresponding functional elements, and specifically the transmitter 103 of FIG. 1 further comprises functionality for receiving and the receiver 105 comprises means for transmitting. Thus, the receiver 105 may transmit data to the transmitter 103 as well as receive it from the transmitter 103.

In the example, the transmitter 103 comprises a data source 107 which is coupled to a transmit controller 109 that controls transmissions to the receiver 105. The transmit controller 109 is coupled to a transceiver 111 which transmits and receives data over the air interface in accordance with the technical specifications of the communication system.

The transmit controller is in particular operable to format and partition data for transmission over the air interface. In addition, the transmit controller 109 operates a retransmission scheme whereby data packets which do not receive an ACKnowledgement message from the receiver 105 are retransmitted after a delay. Repeated retransmissions may occur resulting in some data being transmitted with a significant delay.

In the specific example, the transmit controller 109 is arranged to determine a delay for each data packet to be retransmitted and if the delay exceeds a predetermined delay for the specific communication service, the transmit controller 109 discards the data packet rather than attempt any further retransmissions.

The apparatus 101 comprises a power control processor 113 which is connected to the transceiver 111. The power control processor 113 is arranged to control the transmit power of the transceiver 111 and specifically the transmit power of the transmissions to the receiver 105. The power control processor 113 thus controls the transmit power of the transceiver 111 and thus the signal to noise ratio at the receiver 105. As a consequence, the power control processor 113 controls the error performance of the transmissions between the transmitter 103 and the receiver.

In the example, the receiver 105 comprises functionality for measuring an error rate (such as the bit error rate or the block error rate) of the transmission and to transmit the error rate measurement values back to the transmitter 103.

The transmitter 103 comprises an error parameter processor 115 which is arranged to determine an error parameter. The error parameter can be determined as the difference between a target or reference error rate which is predetermined for the specific service and a current error rate which is determined in response to the error rate measurement received from the receiver 105.

Specifically, the error parameter can be determined as the difference between the target parameter and the current error rate, where the current error rate is determined in response to the error rate received from the receiver 105. The error parameter processor 115 is coupled to the power control processor 113 which controls the transmit power in response to the error parameter received from the error parameter processor 115. Specifically, if the current error rate is higher than the target value, the transmit power is increased resulting in a reduced error rate. In contrast, if the current error rate is lower than the target value, the transmit power is decreased resulting in an increased error rate. Thus the power control processor 113 dynamically controls the transmit power to follow the propagation conditions such that the current error rate is maintained close to the target error rate.

The apparatus 101 further comprises a discarded data processor 117 which is coupled to the transmit controller 109 and the error parameter processor 115. Whenever the transmit controller 109 discards data, e.g. because the delay exceeds a predetermined limit, this is notified to the discarded data processor 117 which then determines a discarded data measure. The discarded data measure indicates an amount of data which has actively been discarded by the transmit controller 109. The discarded data measure may for example be an indication of how many channel data bits have been discarded by the transmit controller 109, i.e. it may indicate how many channel bits would have been transmitted if the data had not been discarded. In other embodiments, the discarded data measure may be a simple binary value indicating whether data has been discarded in a given time interval or not.

The discarded data processor 117 is coupled to the error parameter processor 115. The discarded data measure is fed to the error parameter processor 115 which determines the error parameter in response thereto. Thus, in contrast to conventional power control loops, the power control loop of the example of FIG. 1 is not only operated in response to the transmission error rates of the air interface communication link, but also in response to errors which are intentionally introduced by discarding data that fails to meet certain requirements. Indeed, in some embodiments, the power control may be performed entirely in response to the discarded data measure and the air interface transmission error may be ignored completely. Such an embodiment may be particularly suitable for applications wherein the error rate caused by actively discarding data is substantially higher than the transmission error rate.

In the example of FIG. 1, the error parameter processor 115 may calculate a combined current error rate which includes the transmission errors and the errors from actively discarded data. For example, the receiver 105 may report a bit error rate BER₁ and the discarded data measure may indicate a number of bits N discarded in a given time interval T allowing the error parameter processor 115 to determine a discarded bit error rate BER₂ of N/T; resulting in a combined bit error rate of:

$$B E {R}_{Combined} = \frac{1}{\frac{1}{B E {R}_{1}} + \frac{1}{B E {R}_{2}}}$$

This bit error rate may then be compared to the target error rate and used to control the transmit power.

Specifically, an error signal of:

e=BER_{Combined}−BER_{Target}

may be determined and used to drive the power control loop.

It will be appreciated that the discarded data measure may equally be applied to the target error rate such that this is e.g. determined as:

$$B E {R}_{Modified Target} = \frac{1}{\frac{1}{B E {R}_{Target}} - \frac{1}{B E {R}_{2}}}$$

with a resulting error signal of:

e=BER₁−BER_{ModifiedTarget}

Thus, in contrast to conventional power control loops, the power control loop of the example of FIG. 1 can automatically adjust the transmission power so that not only a given transmission error performance is achieved but also so that a desired delay performance is achieved. The approach may allow an improved and automated trade off between the error control schemes of retransmission and power control taking into account a plurality of parameters, such as the desired error performance and delay performance. Thus, a significantly improved error control performance can be achieved and in particular improved performance for delay sensitive services can be achieved as the number of data discards due to unacceptable retransmission delays can be reduced.

In the following, a more detailed description focussing on embodiments of the invention applicable to a cellular communication system and in particular to a UMTS cellular communication system will be described. However, it will be appreciated that the invention is not limited to this application but may be applied to many other communication systems. The description will focus on power control of a downlink communication but it will be appreciated that the principles are equally applicable to uplink communications.

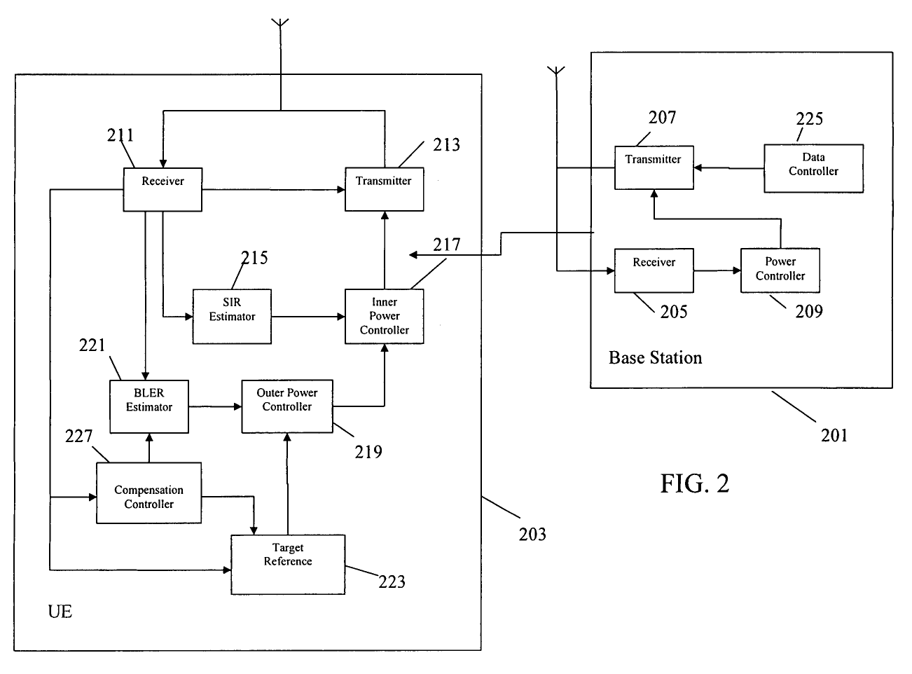

FIG. 2 illustrates a block diagram of a base station 201 and a user equipment 203 (UE) of a cellular communication system 100. The UE 203 may typically be a subscriber unit, a mobile station, a communication terminal, a personal digital assistant, a laptop computer, an embedded communication processor or any communication element communicating over the air interface.

For clarity and brevity, only the elements of the cellular communication system required for describing the specific embodiments are shown in FIG. 2. It will be appreciated that the cellular communication system comprises additional functionality required or desired for the operation and management of a cellular communication system.

In the embodiment of FIG. 2, the base station 201 is supporting a communication service for the UE 203. In the specific example, the communication service is a delay sensitive data packet service wherein data packets are transmitted from the base station 201 to the UE 203. The data packet communication service supports an application of the UE 203, such as for example a video streaming or a voice application.

The communication service is a delay sensitive Acknowledged Mode (AM) service using retransmissions to reduce the error rate. In particular, the communication service uses an Automatic Repeat reQuest (ARQ) scheme where each data packet is positively or negatively acknowledged as is well known in the art. The cellular communication system stores the transmitted data packets in a suitable buffer and if a negative acknowledge message is received from the UE 203, the corresponding data packet is retransmitted. If a positive acknowledgement is received, the corresponding data packet is discarded from the buffer thereby freeing up memory.

Furthermore, if a data packet awaiting retransmission has not been successfully transmitted within a given interval it is discarded rather than transmitted.

It will be appreciated that most of the functionality for the retransmission may be implemented in other network elements than the base station 201 and in particular may be implemented in a Radio Network Controller (RNC) coupled to the base station 201. For example, the data buffer may be implemented in the base station 201 or an RNC (not shown).

The base station 201 comprises a receiver 205 which receives transmissions from the UE 203. As well known to the person skilled in the art, the receiver 205 can receive user data, control messages, data measurements etc from the UE 203. The received data can be forwarded to other network elements such as the RNC (not shown) to which the base station 201 is coupled. In addition, the base station 201 can use received data for the internal operation and control of the base station 201. For example, received data may be used for transmit power control as will be described below.

The base station 201 furthermore comprises a transmitter 207 which is operable to transmit data over the air interface to the UE 203 in accordance with the UMTS technical specifications. In particular, the transmitter 207 transmits the data packets, control messages and broadcast information to the UE 203. The transmitter 207 of the base station 201 transmits the data packets to the UE 203 at a transmit power level that may be varied to suit the current conditions.

The transmitter 207 is coupled to a power controller 209 which is operable to control the transmit power of the transmitter 207. The power controller 209 is coupled to the receiver 205 and receives power control commands from the UE 203. The power control commands may be power up commands resulting in the downlink transmit power being increased or may be power down commands resulting in the downlink transmit power being decreased.

The UE 203 comprises a receiver 211 for receiving signals from the base station 201 and a transmitter 213 for transmitting messages to the base station 201. The UE 203 generates the power control commands for the downlink transmit power control in the following way.

The receiver 211 is coupled to a SIR estimator 215 which generates a SIR estimate for the signal received at the UE 203. In particular, the SIR estimator 215 generates the SIR estimate in response to the characteristics of the messages received by the receiver 211 from the base station 201 as is well known in the art.

The SIR estimator 215 is coupled to an inner power controller 217 which compares the SIR estimate to a SIR reference value. If the SIR estimate is lower than the reference value the inner power controller 217 generates a power up command and if the SIR estimate is higher than the reference value the inner power controller 217 generates a power down command. The inner power controller 217 is coupled to the transmitter 213 which transmits the power commands to the base station 201. Thus, the transmit power of the base station 201 is controlled to achieve a SIR at the UE 203 corresponding to the SIR reference value.

The inner power controller 217 is furthermore coupled to an outer power controller 219, which generates a reference value for the inner power controller 217. In particular, the outer power controller 219 generates the SIR reference value and feeds it to the inner power controller 217. Thus, the inner power controller 217 controls the transmit power to preferably result in a SIR at the UE 203 equal to the SIR reference value generated by the outer power controller 219.

The outer power controller 219 is further coupled to a BLER estimator 221 which determines a BLock Error Rate (BLER) estimate for the signal received at the UE 203. In the described embodiment, the BLER estimator 221 is coupled to the receiver 211 and determines a BLER estimate based on the received messages as is well known in the art. For example, each block may comprise a check sum and if a check sum check is successful, the block is determined to be received without errors, and if the check sum fails, a block error is deemed to have occurred.

The outer power controller 219 further receives a signal quality target from a target reference 223. In particular, the outer power controller 219 receives a target BLER and compares the BLER estimate with this target. If the BLER estimate is lower than the BLER target value, the outer power controller 219 increases the SIR reference value and if the BLER estimate is higher than the BLER target value, the outer power controller 219 decreases the SIR reference value. Thus the outer power controller 219 controls the SIR reference value to result in a desired BLER experienced by the UE 203.

In the described embodiment, the signal quality target is determined in the fixed network and communicated to the UE 203 over the air interface. Thus, in the example, the target reference 223 simply receives a BLER target from the receiver 211.

It will be appreciated that in the cellular communication system of FIG. 2, the error performance is controlled by a double power control loop mechanism with an inner and outer power control loop. In addition, the communication service uses retransmissions to perform error recovery. Hence, two different mechanisms are used to control the error performance and to achieve the desired overall link quality. The inventor has realised that these mechanisms have very different performances and that they in particular impact differently on other characteristics than the error performance. For example, retransmissions introduce additional delays, additional memory requirements for buffering of data packets and additional congestion whereas increased transmit powers result in increased instantaneous interference and increased power consumption.

For some services, such as delay sensitive services, it is important that the power control operation is optimised for more than one parameter. In the example of FIG. 2, the base station 201 comprises a data controller 225 which packetizes the data for the service and controls the retransmission mode. Thus, the data controller 225 buffers data packets until an ACK message has been received. If no ACK message is received for a data packet, this is retransmitted.

In the example, the data controller 225 evaluates a delay criterion for each data packet to be retransmitted. If the delay criterion is not met, the data controller 225 discards the data packet which is consequently not sent to the UE 203. Such a deletion may for example occur after a given time delay has occurred or after a given number of data packet retransmissions have been unsuccessful. Typically, for delay sensitive data services, data received with more than a given delay cannot be used by the receiving application and a resource saving can accordingly be achieved by discarding rather than retransmitting the data.

In the example, data controller 225 generates a data discard message indicating that data has been discarded and transmits this to the UE 203 using the transmitter 207. In the specific example, the data discard message indicates how much data has been discarded for the specific service. This indication may be given as a number of data packets discarded since the last data discard message was transmitted. As another example, the indication may be given as a current packet data discard rate.

The UE 203 comprises a compensation controller 227 which is coupled to the receiver 211. The compensation controller 227 receives the data discard message and in response to this generates a discarded data measure. In some embodiments, the compensation controller 227 may simply determine the discarded data measure by extracting the indication transmitted in the data discard message.

The compensation controller 227 is coupled to the BLER estimator 221 and is operable to modify the BLER estimate generated by the BLER estimator 221 in response to the discarded data measure. For example, the compensation controller 227 can determine the BLER caused by the data discard of the data controller 225 and can feed this to the BLER estimator 221. The BLER estimator 221 can then determine the effective current error rate by combining the transmission errors and the amount of data actively discarded. For example, the BLER can be determined as:

$$B L E R = \frac{1}{\frac{1}{B L E {R}_{Data Discard}} + \frac{1}{B L E {R}_{Transmission}}}$$

wherein BLER_{DataDiscard} is the BLER resulting from data discarding by the data controller 225 and BLERₜᵣₐₙₛₘᵢₛₛᵢₒₙ is the BLER measured for the air interface signal received by the receiver 211. Thus, the measured error rate is increased in response to the discarded data measure.

This modified BLER estimate can then be used by the outer power controller 219 to determine the error signal used to drive the outer power control loop. The outer power controller 219 may specifically calculate the error signal as the difference between the modified BLER estimate and the BLER target.

In the example, compensation controller 227 is further coupled to the target reference and is operable to modify the BLER target. This modification may be an alternative to modifying the BLER estimate or may be used in combination with a modification of the BLER estimate.

The compensation controller 227 is specifically able to modify the BLER target in response to the discarded data measure. Specifically, if many data discards occur, the BLER target may be reduced resulting in a higher transmit power, lower errors, fewer retransmissions, fewer data discards and a lower delay. However, if few data discards occur, the BLER target may be increased resulting in a lower resource usage and interference.

As a specific example, the BLER target may be determined as:

$$B L E {R}_{Modified Target} = \frac{1}{\frac{1}{B L E {R}_{Original Target}} - \frac{1}{B L E {R}_{Data Discard}}}$$

It will be appreciated that including discarded data, as well as incorrectly received data in the error parameter calculation will ensure that the SIR target for the inner control loop is increased following discard of transmit data. This will lead to a lowered air interface error rate and a raised throughput. This should prevent more data being discarded. In this way the link can be, at least partially, self-optimizing as it will (indirectly) consider the delay constraints of the service it carries.

It will be appreciated that the above described principles may equally apply to uplink transmit power control. Indeed, it is respectfully submitted that the example and description of FIG. 2 is equally valid if reference sign 201 is considered to be a UE and reference sign 203 is considered to be a base station.

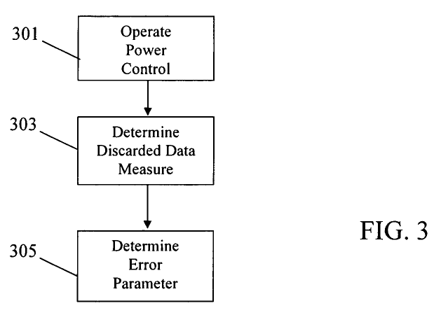

FIG. 3 illustrates a method power control of an air interface transmission between a receiver and a transmitter in accordance with some embodiments of the invention.

The method initiates in step 301 wherein a power control loop for the air interface transmission is controlled in response to an error parameter.

Step 301 is followed by step 303 wherein a discarded data measure indicating an amount of data actively discarded for the air interface transmission is determined.

Step 303 is followed by step 305 wherein the error parameter is determined in response to the discarded data measure.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for power control of an air interface transmission between a receiver and a transmitter; the apparatus comprising:
means for operating a power control loop for the air interface transmission in response to an error parameter;
first determining means for determining a discarded data measure indicating an amount of data actively discarded for the air interface transmission; and
second determining means for determining the error parameter in response to the discarded data measure.

2. The apparatus claimed claim 1 wherein the error parameter is an error rate difference between a measured error rate and a target error rate.

3. The apparatus claimed claim 2 wherein the second determining means is arranged to increase the measured error rate for an increasing amount of discarded data.

4. The apparatus claimed in claim 3 wherein the second determining means is arranged to determine the measured error rate by combining transmission errors and the amount of data actively discarded.

5. The apparatus claimed in claim 2 wherein the second determining means is arranged to decrease the target error rate in response to an increasing amount of discarded data.

6. The apparatus claimed in claim 1 wherein the second determining means comprises means in the receiver for modifying a reference parameter for the error parameter in response to the discarded data measure.

7. The apparatus claimed in claim 1 wherein the second determining means is arranged to determine the error parameter in response to a measured parameter and to modify the measured parameter in response to the discarded data measure.

8. The apparatus claimed in claim 1 wherein the transmitter comprises means for actively discarding data and means for transmitting an indication of the data discard to the receiver, and wherein the transmitter comprises means for retransmitting data over the air interface and wherein the actively discarded data is actively discarded retransmission data.

9. The apparatus claimed in claim 1 wherein the actively discarded data is first data discarded in response to a determination of a delay requirement for the first data being exceeded.

10. A method of power control of an air interface transmission between a receiver and a transmitter; the method comprising:
operating a power control loop for the air interface transmission in response to an error parameter;
determining a discarded data measure indicating an amount of data actively discarded for the air interface transmission; and
determining the error parameter in response to the discarded data measure.
